(19) United States
(12) Patent Application Publication
(10) Pub. No.: US 2013/0004808 A1
(43) Pub. Date: Jan. 3, 2013

(54) CONTROLLABLY THERMALLY INSULATING HOUSING AND METHOD FOR THE CONTROL THEREOF

(75) Inventor: Oliver Tschismar, Metzingen (DE)

(73) Assignee: ROBERT BOSCH GMBH, Stuttgart (DE)

(21) Appl. No.: 13/515,083

(22) PCT Filed: Oct. 14, 2010
(86) PCT No.: PCT/EP2010/065442

§ 371 Date: Sep. 20, 2012

(30) Foreign Application Priority Data
Dec. 9, 2009 (DE) 10 2009 047 695.4

(51) Int. Cl. H01M 10/50; H01M 2/12

(52) U.S. Cl. 429/50; 429/82; 429/62; 429/53

(57) ABSTRACT

The invention relates to a thermally insulated housing system having a housing, which has an inner chamber configured to receive a high capacity accumulator. The housing according to the invention comprises a double wall in which there is a gap, wherein the gap is connected to the inner chamber in a thermally conductive manner by means of at least one inner wall section of the double wall. The gap is connected to the surroundings of the housing by means of at least one outer wall section of the double wall and is completely sealed except for a liquid connection. The housing system further comprises a liquid pump connected to the fluid connection and a liquid tank having liquid. The liquid tank is connected to the inner chamber via the liquid pump. The liquid pump is designed to control the fill level of the liquid in the gap between the wall sections of the double wall. The invention further relates to a method for the controlled cooling of a high capacity accumulator. The high capacity accumulator is arranged in an inner chamber of a housing having a double wall, within which a gap extends. The high capacity accumulator is connected to an inner wall section of the double wall in a thermally conductive manner by means of the arrangement. Heat transfer from the high capacity accumulator via the inner wall section and via an outer wall section of the double wall adjacent to the surroundings of the housing to the surroundings is controlled by changing a fill level of a liquid in the gap which extends between the inner and outer wall section.

### TECHNICAL BACKGROUND

The invention relates to a thermally insulating housing system for controllable temperature adjustment of storage batteries, in particular of high power storage batteries. The invention relates, in particular, to the use of the housing system according to the invention and to a method for cooling traction storage batteries of electrically operated vehicles.

### PRIOR ART

Electrical energy stores such as batteries are based on electrochemical conversion processes, for which reason they are particularly temperature-sensitive. While excessively low temperatures lead to a severe sudden decline in power, at high temperatures damage occurs due to premature ageing, said damage being associated with continuing decreases in power. The temperature of the battery is usually determined by the surroundings and by its own dissipated heat. It is known to use active elements such as Peltier elements or else active compressor-operated cooling units to control the temperature. However, these solutions involve complex systems.

In addition it is known to cool batteries by means of a flow of media and a corresponding heat sink, for example by means of airflow or by a cooling circuit with coolant. In some hybrid vehicles, air cooling or a refrigerating circuit is used which is coupled to an airconditioning system and therefore provides for the compression and evaporation of a refrigerant. However, these methods require a sufficient flow of media, which is, if appropriate, assisted by a compressor, with the result that, on the one hand when the flow is slight a small cooling power is produced, and, on the other hand, in particular in the case of cooling by means of an airconditioning system already existing components have to be additionally loaded or dimensioned in a significantly more costly way.

Document FR 2 869 722 presents a system for thermally insulating a battery in which a material whose thermal resistance depends on the surrounding air pressure is arranged within a housing. The thermal conductivity of the material is therefore changed by changing the air pressure so that the transfer of heat through the housing walls can be modulated. However, the modulation range of the specific thermal conductance value of the material is small.

Document U.S. Pat. No. 3,450,196 describes a housing for batteries in aerospace, in which hydrogen is located in the housing. By changing the pressure, the transfer of heat through the hydrogen is controlled. As also in FR 2 869 722, the device in U.S. Pat. No. 3,450,196 only permits a small bandwidth of the transfer of heat, in particular owing to the limited thermal conductivity of hydrogen. The measures known from the prior part permit only a small modulation range of the controllable thermal conductance value.

An object of the invention is therefore to provide a device and a method with which the temperature of a battery can be controlled in a simple manner with a temperature regulating system which is adjustable over wide ranges.

### DISCLOSURE OF THE INVENTION

This object is achieved by the thermally insulating housing system and the method according to the independent claims.

The invention easily permits the temperature control, i.e. heating or cooling of a traction battery or of another high power storage battery, wherein, if appropriate, the temperature can be lowered and raised by a large amount. The invention provides a temperature regulating system with a transfer of heat which is significantly increased compared to the prior art but which can also be reduced to a minimum. The necessary precautions can be easily implemented and, in particular, do not load the other temperature control systems of a motor vehicle. The housing system according to the invention can also be accommodated in a space-saving fashion in a motor vehicle and permits a particularly high level of conduction away of heat or feeding in of heat, which is not possible with conventional systems which are based on gas. At the same time, the invention permits efficient thermal insulation in order, for example, to prevent heat which arises in the storage battery from remaining within the storage battery when the operating temperature thereof is to be raised.

The concept on which the invention is based is to use not only gas but also fluids as a modulator for the transfer of heat, wherein fluids can be particularly easily conducted out of the corresponding intermediate space or fed into it and permit a high thermal conductance value which cannot be implemented with gases. As a result, by pumping in the fluid the housing can suddenly be provided in a thermally conductive form if, for example, a quantity of heat is to be conducted away to the outside or if the heat from the surroundings is to be used to heat up the storage battery. In addition to the significantly raised maximum thermal conductance value of the housing, the housing can, however, also act in a highly thermally insulating fashion so that the thermally insulating working region of the housing does not provide less thermal insulation than is provided by evacuated intermediate spaces in the prior art.

The housing according to the invention is embodied with a double wall which is essentially closed off and whose content is changed in order to be able to modulate the insulation capability and/or the thermal transmission capability. The housing provides an internal space which is suitable for accommodating the storage battery, wherein an internal wall section permits thermal contact with the internal space and therefore with the storage battery. Since the internal wall section is part of the double wall, a direct thermal bridge is created between the intermediate space and the internal space or the storage battery. In a comparable way, the housing system comprises an external wall section which is part of the double wall and which provides a direct thermal bridge for a heat source or heat sink (in particular the surroundings). The intermediate space is completely closed off by the wall sections apart from a fluid connection by which the filling of the intermediate space can be changed. If appropriate, the double wall can be provided with a pressure-equalization valve in order to permit pressure equalization with respect to the surroundings when emptying and filling occur.

Fluid which can be pumped into the intermediate space via a fluid pump of the housing system or can be removed from the intermediate space is provided in a fluid tank of the housing system. The fluid pump is configured to control the filling level of the fluid in the intermediate space between the wall sections of the double wall (and if appropriate the gas pressure in the intermediate space). As a result, the transfer of heat between the internal wall section and the external wall section can be controlled over wide ranges. In particular water, preferably mixed with an antifreezing agent such as glycol (as a water/glycol mixture) is used as fluid to ensure a particularly high transfer of heat. For example, when water is used a relatively high thermal conductance of approximately 0.6 W/(mK) results in a significantly better transfer of heat between the surroundings and the storage battery in comparison with, for example, air with a thermal conductivity of approximately 0.02 W/(mK). By using water, the transfer of heat can therefore be increased by a factor of more than 10, 20 or more compared to the prior art. In particular when high power storage batteries are used, a high maximum transfer of heat is necessary since large quantities of dissipated heat occur solely owing to the high power of the storage batteries.

In particular, the thermally insulating housing system also comprises the high power storage battery itself, whose external surface is preferably connected in a directly thermally conductive fashion to the internal wall section of the double wall, in particular to the surface thereof which adjoins the internal space. Thermal connections which comprise a thermally conductive paste layer or a thermal pad are also considered to be a direct connection. In addition, heat spreaders can be provided inside the heat bridge in order to increase the surface for the transfer of heat.

Water, which is, if appropriate, mixed with additives, can be used as a modulating thermal conduction medium which is filled into the intermediate space and discharged therefrom. The intermediate space of the double wall can be free of solids or can comprise thermally insulating bodies which have ducts, pores or openings which are open to the intermediate space and can therefore be filled with the fluid. In the same way, the ducts, pores or opening serve to allow water to be removed from the thermally insulating bodies. The thermally insulating bodies comprise, for example, silica, polystyrene foam, polyurethane foam or a glass fiber fabric. The thermally insulating bodies can extend inside the entire intermediate space or can extend in one section, wherein a gap remains between the external or internal wall section and the section in which the thermally insulating bodies are provided. In order to assist the conduction of heat, the wall sections can be provided in the form of plastic layers or metal layers. In the case of plastic layers, they are preferably made thin, in particular thinner than 5, 3 or 2 mm, in order to avoid an undesired accumulation of heat owing to the properties of the plastic material. The entire housing is preferably fabricated essentially from the same material, for example, from injection-molded plastic. Alternatively, the wall sections can comprise additional metal plates, metal layers or metal foils which are provided on the wall sections in order to improve the transfer of heat. The wall sections can be let into the housing which is provided from plastic, or can be applied to the corresponding wall sections of the plastic housing.

The housing system preferably also comprises a controller which has inputs which are configured for connection to temperature sensors which are in turn arranged on the high power storage battery or on the outside of the housing system. Alternatively, the housing system itself can comprise the sensors which are connected to the controller, wherein these sensors detect both the temperature of the high power storage battery and the ambient temperature. The controller also has an output to which the fluid pump is connected. The controller is configured to actuate the pump in order to fill and to empty the intermediate space. Depending on whether or not the temperature of the storage battery is to be matched to the external temperature, the filling level is raised or reduced. If the temperature of the storage battery is to move in the direction of the temperature of the surroundings, the filling level is raised. Otherwise, the filling level is reduced.

A predefined temperature value, which serves as a setpoint variable, for the storage battery temperature, is preferably used. If the difference between the storage battery temperature and the surroundings has the same sign as the difference between the storage battery temperature and the predefined temperature value, the controller is configured to actuate the fluid in order to raise the filling level. If the differences have a different sign, the filling level is reduced. The controller can receive the predefined temperature value and preferably has a comparator for comparing the storage battery temperature with the ambient temperature and for comparing the storage battery temperature with the predefined temperature value. The difference between the storage battery temperature and the ambient temperature, and in particular the sign thereof, indicate the direction in which the storage battery temperature would change if a thermally conductive connection were to be made to the ambient temperature. If this direction of change corresponds to the setpoint direction which is represented by the difference between the storage battery temperature and the predefined temperature value, the filling level is raised and therefore the transfer of heat is provided. The controller is preferably configured to provide the filling level in a binary fashion with the result that either the intermediate space is completely filled with fluid or the fluid is completely removed from the intermediate space. In this case, the controller preferably has an automatic deactivation means which switches off the pump if the filling level is zero or if the full level has been reached.

In addition to the modulation by means of the filling level of the fluid, the invention can also be configured to at least partially evacuate the intermediate space. For this purpose, the housing system has a vacuum pump which is connected to the intermediate space and is configured to reduce the pressure of the air within the intermediate space, in particular to 50%, 20%, 10%, 5%, 1% or 0.5% of the normal pressure (1.01325 bar at 20° C.). The vacuum pump can be provided separately from the fluid pump. In an alternative embodiment, the fluid pump is configured to also evacuate the intermediate space. In this case, the vacuum pump and the fluid pump are represented by one and the same pump, for example a piston pump or the like. The filling level of the fluid is controlled between 0% and 100%. A fluid filling level of 0% also comprises an empty intermediate space (filled essentially with gas) if the latter still contains several drops or residues of old fluid.

The housing system preferably has a multiplicity of interior spaces which, as described above, are surrounded by double walls. The housing is preferably in the shape of a right parallelepiped, wherein at least one side is embodied as a double wall. If the housing system comprises a plurality of internal spaces, the internal spaces are separated from one another by the double walls. The intermediate spaces of a plurality of double walls are preferably connected to one another. In one preferred embodiment, the housing system is in the shape of a right parallelepiped, wherein all the sides which follow one another in the circulation direction are configured as double walls, wherein the floor or else the lid are not embodied as a double wall. However, the floor is also preferably embodied as a double wall in order to permit corresponding cooling. A heat-transmitting element can be provided between the storage battery and wall section so that the batteries do not have to be fitted precisely into the internal space but instead the heat-transmitting element can be inserted after the insertion of the storage battery in order thereby to close the heat bridge. Further embodiments comprise elastic wall sections which at least slightly bulge out as a result of the water pressure, in order, as a result, to be pressed onto the storage battery by means of a form fit.

Further embodiments take into account the thermal capacity of the water. Here, it is, under certain circumstances, not desired for the temperature of the fluid itself to have a significant influence on the temperature control of the storage battery. In such embodiments, the volume of the intermediate space or of all the intermediate spaces is only a fraction of the volume of the internal space. The internal space preferably has a small width of less than 5, 2, 1 or 0.5 cm, while the internal space has a multiple thereof as a length measure or width measure. The internal space therefore preferably has a length of more than 10 cm, more than 20 cm or more than 50 cm. The ratio of the volumes of all the internal spaces to all the intermediate spaces is preferably more than 50:1, 100:1, 200:1, 500:1, 1000:1 or more. However, alternative embodiments selectively take into account the thermal capacity of the fluid, the cooling associated therewith, heating and cooling effects as a result of evaporating fluid, in particular if the intermediate space is evacuated (or partially evacuated).

The invention is also implemented by a method for controlled cooling, wherein at first at least one high power storage battery is arranged in the internal space and is connected in a thermally conductive fashion to an internal wall section of the double wall. The transfer of heat between the high power storage battery and the surroundings (via the internal and external wall sections through the intermediate space, i.e. through the double wall) is controlled by changing the filling level of the fluid in the intermediate space.

The filling level is changed by filling or removing fluid from the intermediate space by pumping the fluid or discharging the fluid by means of a valve. If, for example, the tank of the valve is provided above the double wall, it is sufficient for a valve to be opened in order to fill the intermediate space. The tank preferably has a ventilation mechanism so that when the intermediate space is filled air is conducted into the tank and when the intermediate space is emptied air is discharged from the tank, preferably via a one-way valve. Since the intermediate space only has a relatively small volume, for example 1-5 l and the intermediate space is therefore provided essentially in the form of a thin layer, the tank can also be made correspondingly small and the pump can transport all the fluid of the tank from the tank into the immediate space, and vice versa, in a short time. According to the method, fluid is therefore conducted from a tank connected to the intermediate space into said intermediate space or is carried from said intermediate space into the tank. In addition to the modulation by the filling level of the fluid, the transfer of heat can also be controlled by additionally reducing the air pressure with respect to the normal pressure. The air is removed after the fluid has been completely removed from the intermediate space, wherein in this context the same pump as that for feeding the fluid can be used or different pumps can be used. In the case of separate pumps, in order to prevent the vacuum pump being activated when there is still fluid in the intermediate space, a sensor may be provided in the intermediate space, according to the method the sensor being interrogated as to whether there is still fluid in the intermediate space.

In addition to water, other desired fluids may also be used as the mediator for the transmission of heat in so far as they have a specific thermal capacity of more than 0.03 or 0.05 or 0.1 W/m/·K. In addition, pure water or water with additives can be used, and the additives are, for example, salts which increase the thermal conductivity even further and/or are preservation materials for ensuring that the operation of the system continues to be ensured for a relatively long time.

### BRIEF DESCRIPTION OF THE DRAWING

FIG. 1 shows a thermally insulating housing system according to the invention.

### DETAILED DESCRIPTION OF THE DRAWING

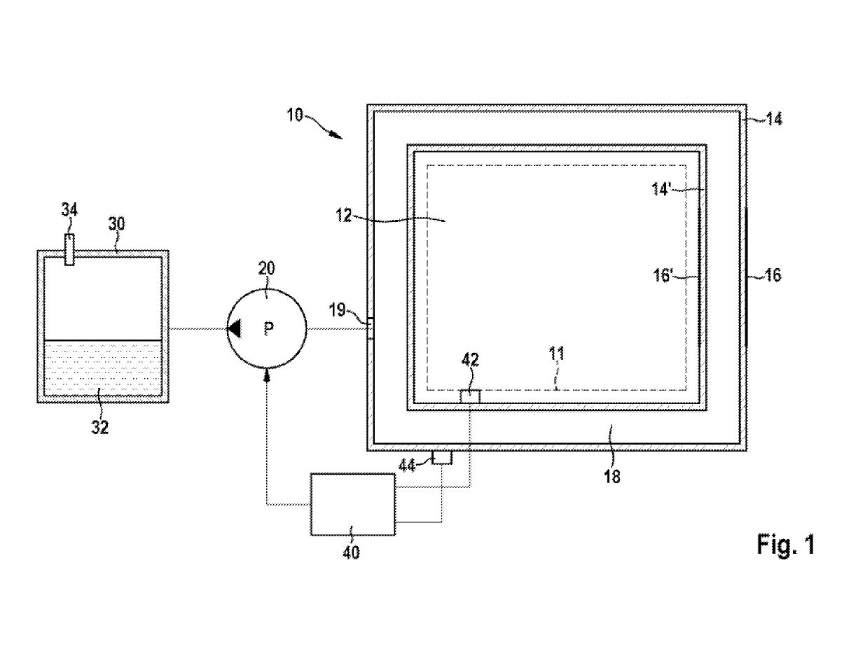

FIG. 1 shows a housing system according to the invention having a housing 10, a pump 20 and a tank 30. The housing 10 comprises an internal space 12 whose dimensions and proportions are configured to accommodate a storage battery, for example a certain type of storage battery. The housing 10 comprises a double wall 14, 14′, wherein the inside of the double wall 14′ comprises an internal wall section 16′, and the external wall of the double wall comprises an external wall section 16. The double wall is circumferential and defines a coherent intermediate space 18 which is configured between the internal wall 14′ and the external wall 14. The intermediate space 18 is essentially closed off, wherein an opening 19 provides a fluid connection for filling and emptying the intermediate space 18.

The pump 20 is connected to the connection 19 and is in turn connected to a tank 30. The pump 20 can be operated in both directions and can therefore pump water 32 from the tank 30 into the intermediate space 18, and can pump water from the intermediate space 18 into the tank 30.

In order to equalize the pressure, the tank also comprises a pressure equalization valve 34 in order to equalize, on the one hand, the increase in pressure within the tank 30 by taking up pumped-in fluid 32 and, on the other hand in order to permit equalization of pressure when pumping out the fluid 32 by feeding in air from the outside. Even though the pump 20 is represented as a hydraulic pump, it is preferably also suitable for pumping gas, in particular from the intermediate space 18 into the tank or preferably into the surroundings in order, as a result, to evacuate the intermediate space 18 and to largely prevent a flow of heat.

The pump 20 is actuated by a controller 40 which is connected to a first temperature sensor 42 which is arranged in the internal space 12 and which is configured to detect the ambient temperature with an external space sensor 44. The controller also comprises a comparator and an input or a memory (likewise not illustrated) for a predefined temperature value in order, according to the invention, to determine whether the intermediate space is to be filled with water or is to be provided in a thermally insulating form, i.e. with a filling level of zero. The predefined temperature value can be stored, in particular, in a read-only memory of the controller 40 and corresponds to the minimum operating temperature of the storage battery which is located in the internal space 12.

1. A thermally insulating housing system having a housing (10) which comprises an internal space (12) configured to accommodate a high power storage battery (11), wherein the housing comprises a double wall in which an intermediate space (18) is provided, wherein the intermediate space is connected in a thermally conductive fashion to the internal space via at least one internal wall section (14′) of the double wall, the intermediate space is connected to surroundings of the housing via at least one external wall section (14) of the double wall, and the intermediate space is completely closed off with the exception of a fluid connection (19), characterized in that the housing system also comprises a fluid pump (20), connected to the fluid connection, and a fluid tank (30) with fluid (32), which fluid tank (30) is connected to the intermediate space (18) via the fluid pump (20), wherein the fluid pump (20) is configured to control a filling level of the fluid in the intermediate space between the wall sections (16, 16′) of the double wall.

2. The thermally insulating housing system as claimed in claim 1, which also comprises a high power storage battery having an external surface connected in a thermally conductive fashion to the internal wall section (14′) of the double wall, wherein the transfer of heat between the high power storage battery and the surroundings through the intermediate space (18) can be adjusted by means of the filling level of the fluid.

3. A thermally insulating housing system as claimed in claim 1, wherein the fluid (32) is water and the intermediate space is free of solids or is filled with thermally insulating bodies which have ducts, pores or openings which are open to the intermediate space so that water can penetrate the ducts, pores or openings when the filling level is raised, and the wall sections (14, 14′) comprise thin, thermally conductive plastic layers or metal layers.

4. A thermally insulating housing system as claimed in claim 1 having a controller (40) which is configured to detect the storage battery temperature of the high power storage battery (11) and an ambient temperature, wherein the controller is also configured to actuate the fluid pump (20) and to take into account a predefined temperature value, wherein the controller is configured to actuate the fluid pump in order to increase the filling level if the difference between the storage battery temperature and the ambient temperature has the same sign as the difference between the storage battery temperature and the predefined temperature value, and is configured to actuate the fluid pump in order to reduce the filling level if the difference between the storage battery temperature and surroundings has the opposite sign to the difference between the storage battery temperature and the predefined temperature value.

5. The housing system as claimed in claim 1, which housing system also comprises a vacuum pump which is connected to the intermediate space (18) and is configured to reduce the pressure of air present in the intermediate space.

6. A method for the controlled cooling of a high powered storage battery with the steps: arranging the high power storage battery in an internal space (12) of a housing (10) with a double wall within which an intermediate space extends, wherein the high power storage battery is connected in a thermally conductive fashion to an internal wall section of the double wall as a result of the arrangement; and controlling a transfer of heat from the high power storage battery (11) to the surroundings via the internal wall section (14′) and via an external wall section (14) of the double wall, said external wall section (14) adjoining the surroundings of the housing, wherein the transfer of heat is controlled by changing a filling level of a fluid in the intermediate space (18), which fluid extends between the internal wall section and the external wall section.

7. The method as claimed in claim 6, wherein the control process comprises filling in fluid in order to raise the filling level and removal of fluid in order to reduce the filing level by one of pumping the fluid and changing the opening state of a valve.

8. The method as claimed in claim 6, wherein in order to control the transfer of heat the fluid is conducted from a tank (30) connected to the intermediate space (18) into the intermediate space or is conducted from the intermediate space into the tank (30).

9. The method as claimed in claim 6, wherein the controlling of the transfer of heat comprises changing an air pressure within the intermediate space by reducing the air pressure by pumping air out of the intermediate space (18).

10. The method as claimed in claim 9, wherein the air pressure is reduced only when there is essentially no fluid in the intermediate space.

11. The housing system as claimed in claim 1, which housing system also comprises a vacuum pump which is connected to the intermediate space (18) and is configured to reduce the pressure of air present in the intermediate space to less than 50%, 20%, 10%, 5%, 1% or 0.1% of the normal pressure.

12. The method as claimed in claim 6, wherein the controlling of the transfer of heat comprises changing an air pressure within the intermediate space by reducing the air pressure to less than 50%, 20%, 10%, 5%, 1% or 0.1% of the normal pressure by pumping air out of the intermediate space (18).
